(19) United States
(12) Patent Application Publication
(10) Pub. No.: US 2003/0213331 A1
(43) Pub. Date: Nov. 20, 2003

(54) Handle grip system

(76) Inventor: Brian A. Croft, Lewisville, TX (US)

Correspondence Address: Michael S. Neustel, Suite No. 4, 2534 South University Drive, Fargo, ND, 58103, US

(21) Appl. No.: 10/150,040

(22) Filed: May 15, 2002

(51) Int. Cl. B62K 21/26

(52) U.S. Cl. 74/551.9

(57) ABSTRACT

A handle grip system for ergonomically positioning a rider's hands upon the handlebars. The handle grip system includes a main body having a front portion and a rear portion, an inner flange extending from an inner end of the main body, an outer flange extending from a distal end of the main body, and a stop member extending from the front portion near the inner flange for receiving the index finger of the rider. A straight bore extends through the main body from the inner end for snugly fitting upon a handlebar. The rear portion preferably has a convex structure with a plurality of rear channels within. The front portion preferably has a concave structure extending from the stop member to the outer flange. The main body preferably has an oblong cross sectional structure with the width being greater than the height. An outer channel and an inner channel preferably extend completely about the perimeter of the inner section and outer section of the main body respective.

### CROSS REFERENCE TO DISCLOSURE DOCUMENT

A Disclosure Document was filed with the Disclosure Document Program on Feb. 21, 2002 and identified by Disclosure Document No. 506,647. The present application hereby incorporates by reference the information contained within Disclosure Document No. 506,647.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to handlebar grips and more specifically it relates to a handle grip system for ergonomically positioning a rider's hands upon the handlebars.

2. Description of the Related Art

Handlebar grips for motorcycles, bicycles, all-terrain vehicles (ATVs), snowmobiles, personal watercraft and other vehicles have been in use for years. Typically, conventional handlebar grips are comprised of a straight tubular structure with flanged portions that are attached to the distal opposing portions of the handlebars.

The main problem with conventional handlebar grips is that they are difficult for riders to grasp over extended periods of time leading to physical stress, fatigue and “arm pump.” Another problem with conventional handlebar grips is that the rider's hands sometimes accidentally are removed from the grips.

Examples of patented devices which may be related to the present invention include U.S. Pat. No. 331,183 to Henson; U.S. Pat. No. 300,506 to Pedone; U.S. Pat. No. 267,147 to Jannard; U.S. Pat. No. 144,446 to Black; U.S. Pat. No. 368,011 to McCoy; U.S. Pat. No. 424,997 to Tamaribuchi; U.S. Pat. No. 241,806 to Johnson; and U.S. Pat. No. 378,345 to Austin et al.

While these devices may be suitable for the particular purpose to which they address, they are not as suitable for ergonomically positioning a rider's hands upon the handlebars. Conventional handlebar grips are comprised of a straight structure that make it difficult to retain a comfortable and secure grip by a rider.

In these respects, the handle grip system according to the present invention substantially departs from the conventional concepts and designs of the prior art, and in so doing provides an apparatus primarily developed for the purpose of ergonomically positioning a rider's hands upon the handlebars.

### BRIEF SUMMARY OF THE INVENTION

In view of the foregoing disadvantages inherent in the known types of handlebar grips now present in the prior art, the present invention provides a new handle grip system construction wherein the same can be utilized for ergonomically positioning a rider's hands upon the handlebars.

The general purpose of the present invention, which will be described subsequently in greater detail, is to provide a new handle grip system that has many of the advantages of the handlebar grips mentioned heretofore and many novel features that result in a new handle grip system which is not anticipated, rendered obvious, suggested, or even implied by any of the prior art handlebar grips, either alone or in any combination thereof.

To attain this, the present invention generally comprises a main body having a front portion and a rear portion, an inner flange extending from an inner end of the main body, an outer flange extending from a distal end of the main body, and a stop member extending from the front portion near the inner flange for receiving the index finger of the rider. A straight bore extends through the main body from the inner end for snugly fitting upon a handlebar. The rear portion preferably has a convex structure with a plurality of rear channels within. The front portion preferably has a concave structure extending from the stop member to the outer flange. The main body preferably has an oblong cross sectional structure with the width being greater than the height.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a handle grip system that will overcome the shortcomings of the prior art devices.

A second object is to provide a handle grip system for ergonomically positioning a rider's hands upon the handlebars.

Another object is to provide a handle grip system that comfortable and securely receive the hands of a vehicle rider.

An additional object is to provide a handle grip system that may be utilized upon various types of handlebars and vehicles.

A further object is to provide a handle grip system that reduces rider fatigue and reduces the chance of incurring arm pump.

Another object is to provide a handle grip system that provides a parallel gripping structure.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper front perspective view of the present invention.

FIG. 2 is an upper front perspective view of the present invention attached to a handlebar.

FIG. 3 is an upper rear perspective view of the present invention.

FIG. 4 is a top view of the present invention.

FIG. 5 is a top view of the present invention rotated 180 degrees from FIG. 4.

FIG. 6 is a cross sectional view taken along line 6-6 of FIG. 1.

FIG. 7 is an inner end view of the present invention.

FIG. 8 is an outer end view of the present invention.

FIG. 9 is a rear view of the present invention. FIG. 10 is a front view of the present invention.

### DETAILED DESCRIPTION OF THE INVENTION

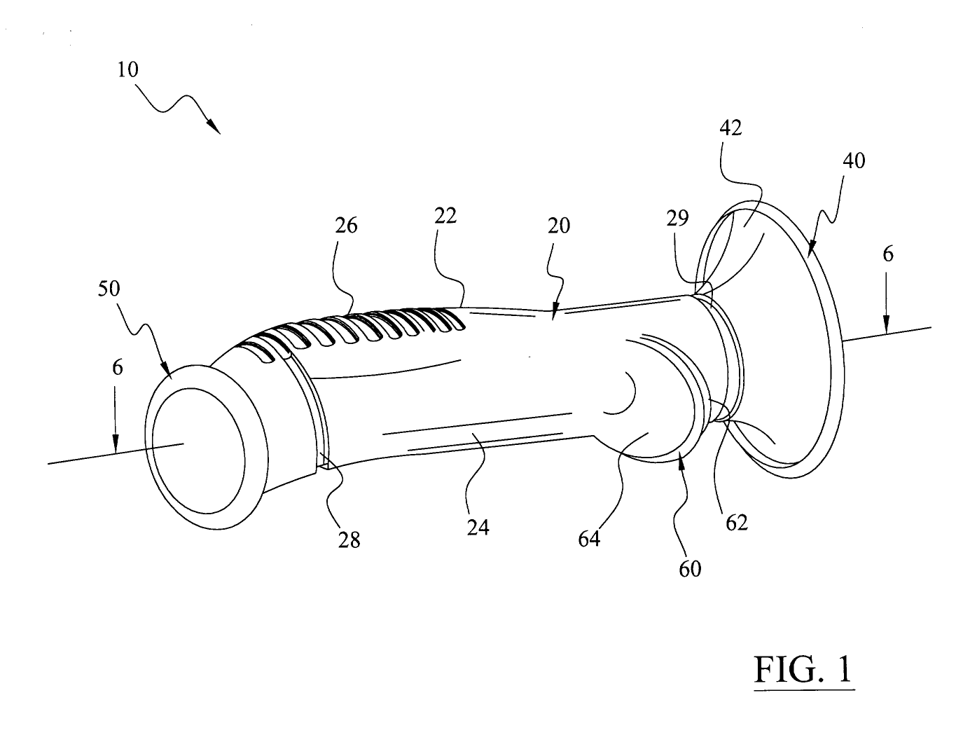

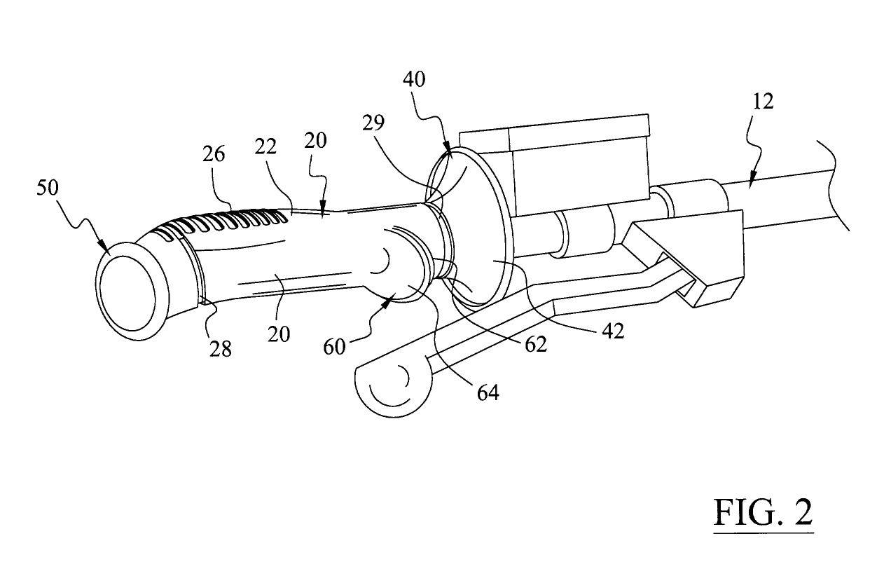

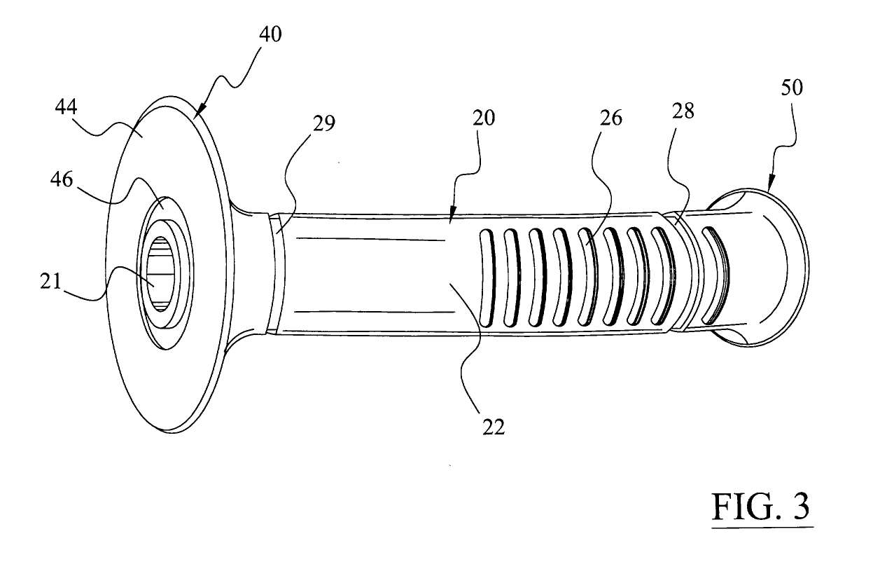

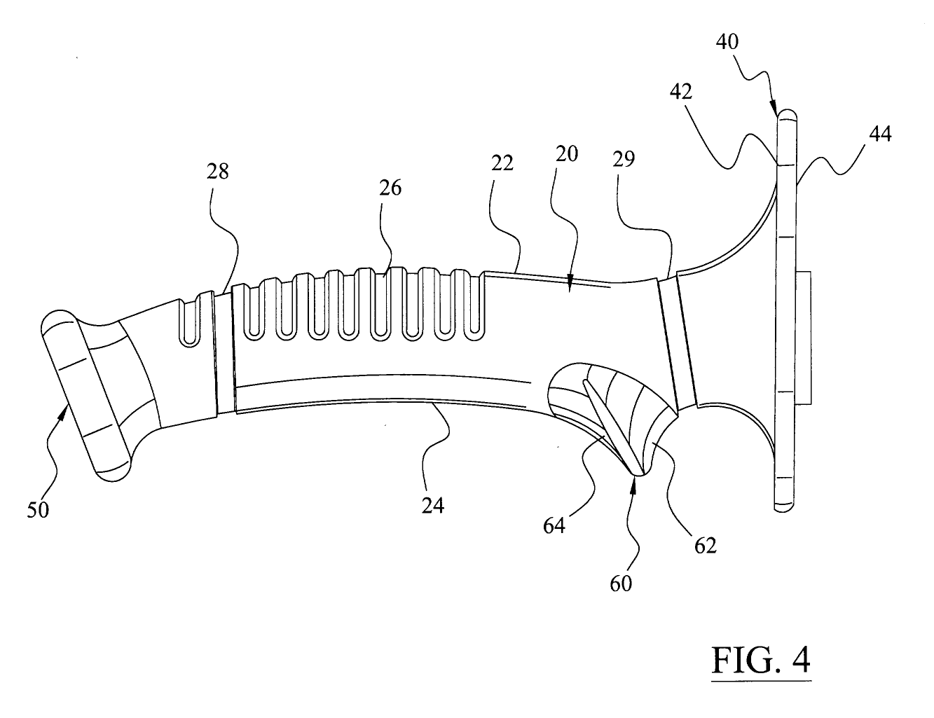

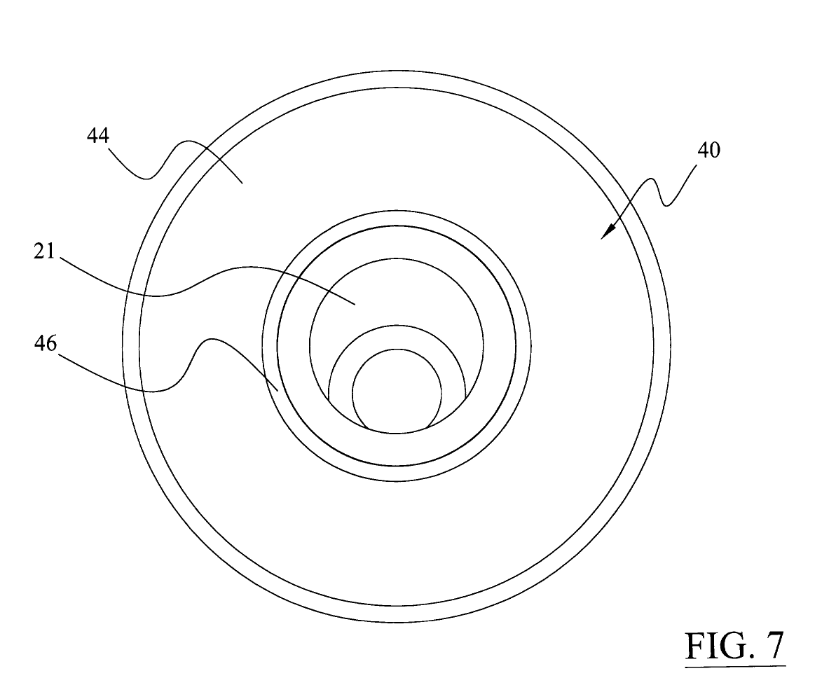

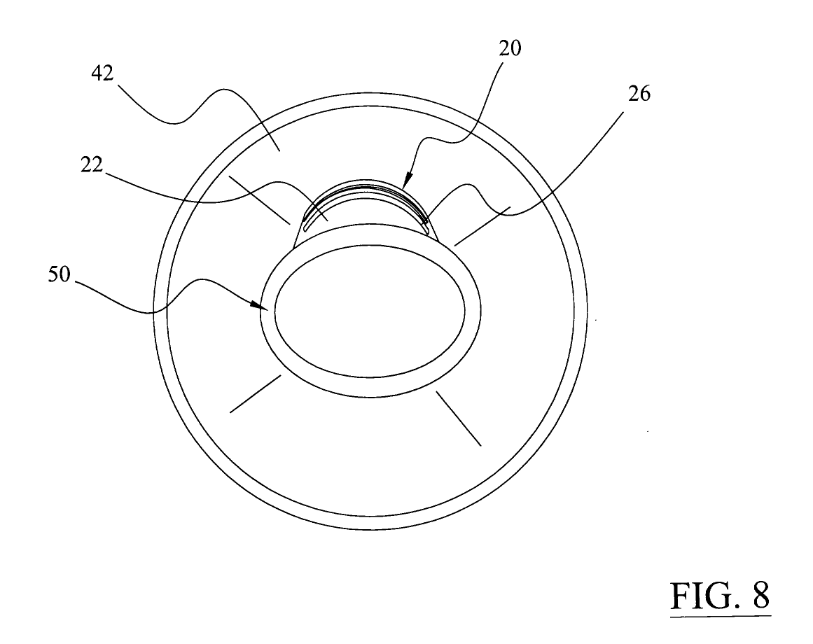

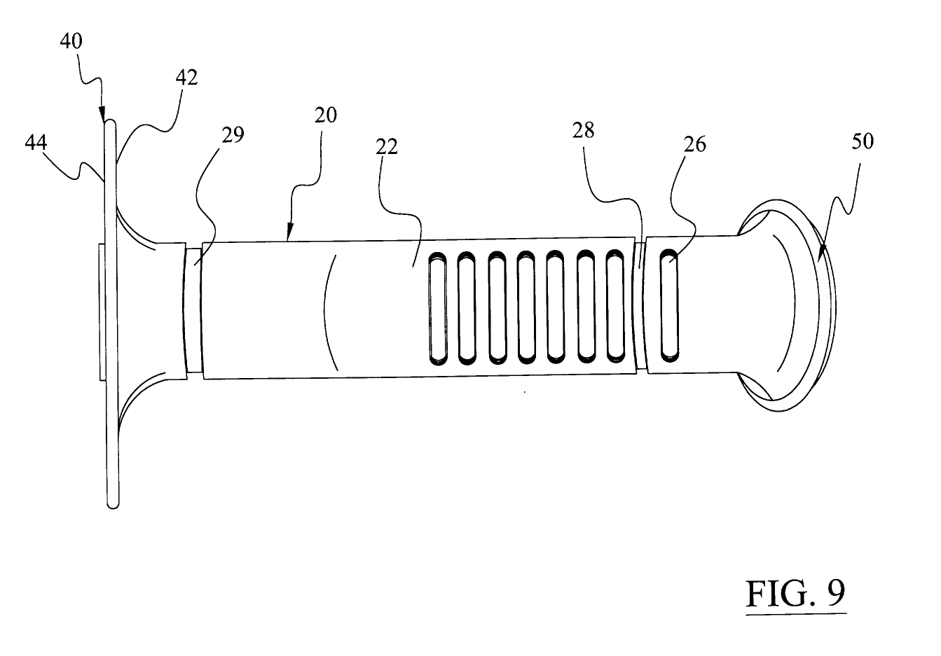

Turning now descriptively to the drawings, in which similar reference characters denote similar elements throughout the several views, FIGS. 1 through 10 illustrate a handle grip system 10, which comprises a main body 20 having a front portion 24 and a rear portion 22, an inner flange 40 extending from an inner end of the main body 20, an outer flange 50 extending from a distal end of the main body 20, and a stop member 60 extending from the front portion 24 near the inner flange 40 for receiving the index finger of the rider. A straight bore 21 extends through the main body 20 from the inner end for snugly fitting upon a handlebar 12. The rear portion 22 preferably has a convex structure with a plurality of rear channels 26 within. The front portion 24 preferably has a concave structure extending from the stop member 60 to the outer flange 50. The main body 20 preferably has an oblong cross sectional structure with the width being greater than the height.

As shown in FIGS. 1 through 6 of the drawings, the main body 20 is comprised of an elongate structure having a front portion 24, a rear portion 22 and a bore 21 extending from the inner end thereof. The bore 21 is formed for snugly receiving the handlebar 12 of a vehicle such as but not limited to a motorcycle, bicycle, snowmobile, personal watercraft or ATV. The main body 20 is preferably comprised of a flexible material such as but not limited rubber, plastic or related materials.

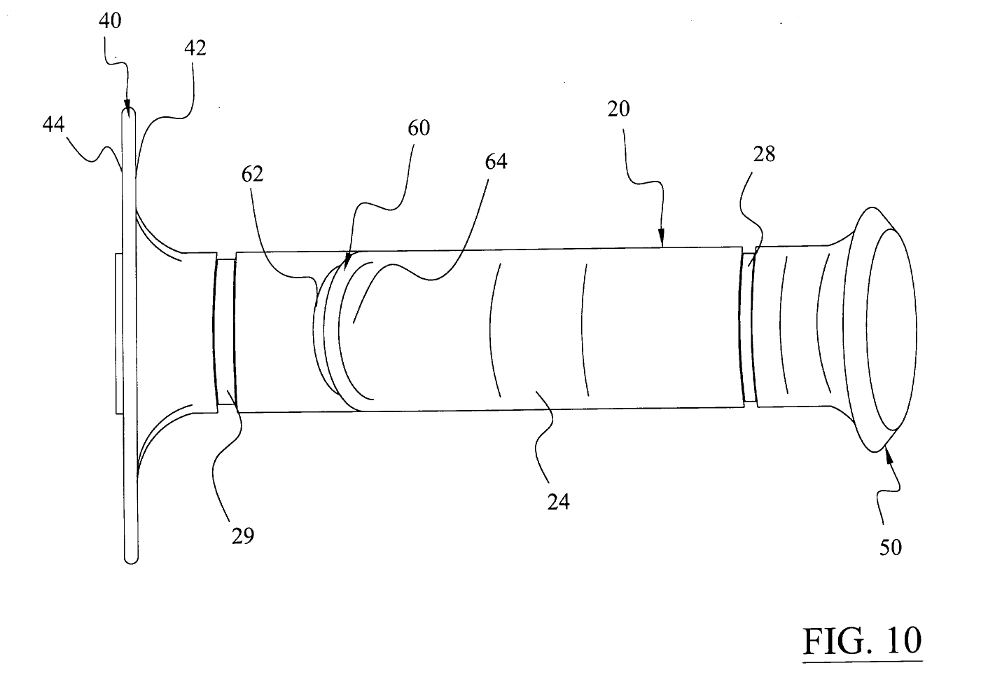

The main body 20 may have a consistent or varying cross sectional structure through the length of the main body 20. The main body 20 preferably has an oblong or oval shaped cross sectional structure having a constant height (measured from top to bottom) and a varying width (measured from front to back). The width of the main body 20 is preferably greater than the height thereby creating the desired oblong structure that comfortably and securely fits within the hands of the rider. The main body 20 preferably has a width of between 1.10 to 1.50 inches. The main body 20 preferably has a height between than 0.90 to 1.10 inches. The height of the main body 20 is preferably relatively consistent through the entire length of the main body 20 as best shown in FIGS. 9 and 10 of the drawings.

As shown in FIGS. 1 through 6 of the drawings, an outer flange 50 extends from the distal end of the main body 20. The outer flange 50 may be comprised of various structures, however, the outer flange 50 is preferably traversely and radially extends from the distal end of the main body 20 as best illustrated in FIGS. 1, 5 and 6 of the drawings. The outer flange 50 may have various shapes such as but not limited to circular, oblong, oval and the like. The outer flange 50 may have various sizes, however the outer flange 50 must have at least a portion thereof that extends outwardly from the distal end of the main body 20. The outer flange 50 preferably has a width greater than 1.20 inches.

As shown in FIGS. 1 through 6 of the drawings, an inner flange 40 extends from the inner end of the main body 20 having an outer surface 42, an inner surface 44 and an inner groove 46. The inner flange 40 may be comprised of various structures, however, the inner flange 40 is preferably traversely and radially extends from the inner end of the main body 20 as best illustrated in FIGS. 1, 5 and 6 of the drawings. The inner flange 40 may have various shapes such as but not limited to circular, oblong, oval and the like. The inner flange 40 may have various sizes, however the inner flange 40 must have at least a portion thereof that extends outwardly from the inner end of the main body 20.

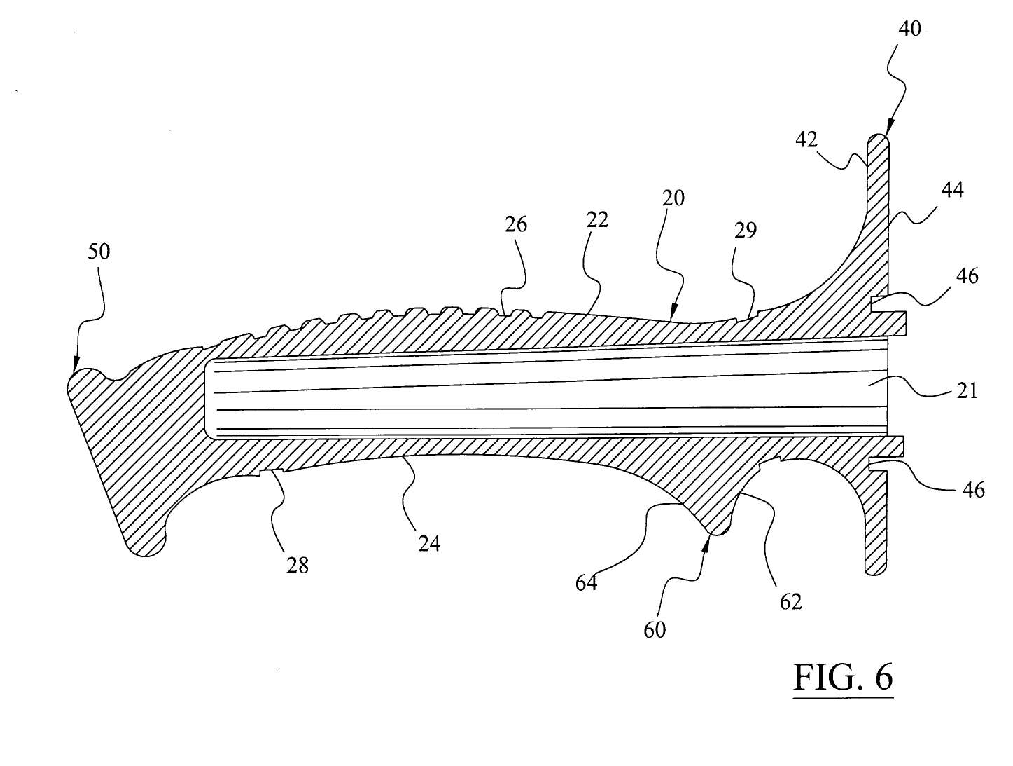

As shown in FIG. 6 of the drawings, the inner flange 40 preferably has a greater size than the outer flange 50. In addition, the inner flange 40 preferably forms a plane that is at an acute angle with respect to a plane formed by the outer flange 50 as best shown in FIG. 6 of the drawings. The inner flange 40 preferably has a width greater than 2.0 inches.

As shown in FIGS. 4, 5 and 6 of the drawings, the rear portion 22 preferably has a convex structure with a plurality of rear channels 26 within. An inner channel 29 preferably extends about the entire perimeter of the main body 20 a finite distance from the inner flange 40 with an angle respect thereto. The thickness of the rear portion 22 increases away from the inner channel 29 until approximately centrally positioned within the rear channels 26 and thereafter begins to decrease. As best shown in FIG. 6 of the drawings, the outer perimeter of the distal portion of the rear portion 22 is angled past a rear plane of the bore 21.

As shown in FIGS. 1 through 6 and 9 of the drawings, a plurality of rear channels 26 extend a finite distance into the rear portion 22 of the main body 20. The plurality of rear channels 26 are preferably substantially parallel to one another and have approximately equal lengths. In addition, the spacing between each of the rear channels 26 is preferably equal. It can be appreciated that variations of the rear channels 26 may be utilized to achieve a similar gripping structure. An outer channel 28 preferably extends through one of the outer rear channels 26 and the entire perimeter of the main body 20 as shown in FIGS. 1 through 6 of the drawings. The outer channel 28 is preferably substantially parallel to the inner flange 40 as best illustrated in FIG. 4 of the drawings. Each of the plurality of rear channels 26 has a width greater than 0.08 inches and a depth greater than 0.02 inches.

As shown in FIGS. 4, 5 and 6 of the drawings, the front portion 24 preferably has a concave structure extending from the stop member 60 to the outer flange 50. The front portion 24 is preferably thicker about the bore 21 within the outer sections thereof than the middle section as best shown in FIG. 6 of the drawings. The respective curvatures of the front portion 24 and the rear portion 22 of the main body 20 with respect to the straight bore 21 provide an outer curved structure that is ergonomic for the rider to grasp by positioning their hands outwardly with respect to the handlebar 12 instead of extending traversely from the handlebar 12 as conventional grips.

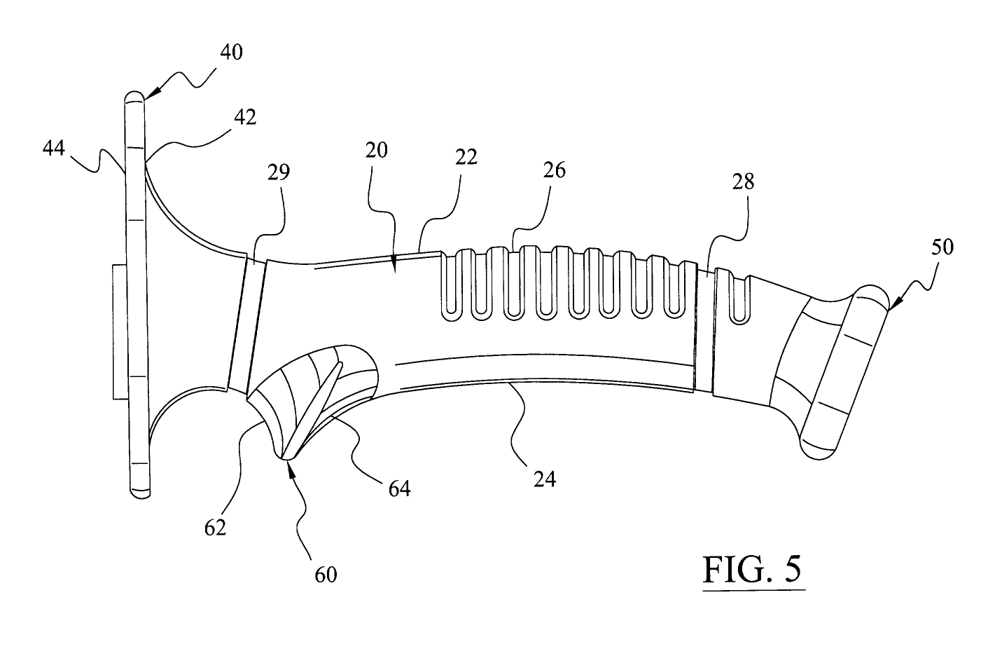

As shown in FIGS. 1, 2, 4, 5, 6 and 10 of the drawings, the stop member 60 extends from the front portion 24 of the main body 20 near and a finite distance from the inner flange 40 in a tapered manner. The stop member 60 preferably extends at an angle from the front portion 24 towards the inner flange 40 as best shown in FIGS. 4 and 5 of the drawings. The stop member 60 has an inner portion 62 and an outer portion 64 which are both preferably curved in structure. The inner portion 62 of the stop member 60 forms a receiving slot that receives the index finger of the rider when grasping the handle grip system 10. The stop member 60 prevents the rider's hand from slipping from the main body 20 in a longitudinal manner. The distance from the outer perimeter of the stop member 60 and the outer perimeter of the inner flange 40 is preferably greater than 1.00 inches.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A handle grip system, comprising:
a main body having a bore, an inner end, an outer end, a front portion and a rear portion; and
a stop member extending from said front portion a finite distance from said inner end for receiving an index finger of a rider.

2. The handle grip system of claim 1, wherein said stop member is comprised of a tapered structure.

3. The handle grip system of claim 1, wherein said stop member has an inner portion and an outer portion, wherein said inner portion and said outer portion are curved.

4. The handle grip system of claim 1, wherein an outer perimeter of said stop member is at least 1.00 inches away from said inner end of said main body.

5. The handle grip system of claim 1, wherein said rear portion is comprised of a convex structure.

6. The handle grip system of claim 1, wherein said front portion is comprised of a concave structure.

7. The handle grip system of claim 1, wherein said rear portion is comprised of a convex structure and wherein said front portion is comprised of a concave structure.

8. The handle grip system of claim 1, including a plurality of rear channels extending into said rear portion of said main body substantially traversely to said bore.

9. The handle grip system of claim 8, including an outer channel extending through one of said plurality of rear channels and about the entire perimeter of said main body.

10. The handle grip system of claim 1, including an inner channel extending about the entire perimeter of said main body between said stop member and said inner end.

11. A handle grip system, comprising:
a main body having a bore, an inner end, an outer end, a front portion and a rear portion, wherein said main body has a height and a width, and wherein said width is greater than said height; and
a stop member extending from said front portion a finite distance from said inner end for receiving an index finger of a rider.

12. The handle grip system of claim 11, wherein said stop member is comprised of a tapered structure.

13. The handle grip system of claim 11, wherein said stop member has an inner portion and an outer portion, wherein said inner portion and said outer portion are curved.

14. The handle grip system of claim 11, wherein an outer perimeter of said stop member is at least 1.00 inches away from said inner end of said main body.

15. The handle grip system of claim 11, wherein said rear portion is comprised of a convex structure.

16. The handle grip system of claim 11, wherein said front portion is comprised of a concave structure.

17. The handle grip system of claim 11, wherein said rear portion is comprised of a convex structure and wherein said front portion is comprised of a concave structure.

18. The handle grip system of claim 11, including a plurality of rear channels extending into said rear portion of said main body substantially traversely to said bore.

19. The handle grip system of claim 11, wherein said width is between 1.11 to 1.50 inches and wherein said height is between 0.90 to 1.10 inches.

20. A handle grip system, comprising:
a main body having a bore, an inner end, an outer end, a front portion and a rear portion, wherein said main body has a height and a width, and wherein said width is greater than said height;
wherein said rear portion is comprised of a convex structure;
wherein said front portion is comprised of a concave structure;
a stop member extending from said front portion a finite distance from said inner end for receiving an index finger of a rider, wherein said stop member is comprised of a tapered structure, and wherein an outer perimeter of said stop member is at least 1.00 inches away from said inner end of said main body; and
a plurality of rear channels extending into said rear portion of said main body substantially traversely to said bore.
